(19) United States
(12) Patent Application Publication
(10) Pub. No.: US 2007/0173622 A1
(43) Pub. Date: Jul. 26, 2007

(54) Continuous Bulk Polymerization In A Planetary Roller Extruder

(75) Inventors: John K. Tynan JR., Port Huron, MI (US); Mark A. Lewandowski, Fort Gratiot, MI (US); Richard W. St. Coeur, Marysville, MI (US)

Correspondence Address: THOMPSON HINE L.L.P.;Intellectual Property Group, P.O. BOX 8801, DAYTON, OH, 45401-8801, US

(73) Assignee: CENTRAL PRODUCTS COMPANY, Bradenton, FL (US)

(21) Appl. No.: 11/620,835

(22) Filed: Jan. 8, 2007

Related U.S. Application Data
(60) Provisional application No. 60/761,535, filed on Jan. 24, 2006.

(51) Int. Cl. C08F 118/02

(52) U.S. Cl. 526/319; 264/211.24

(57) ABSTRACT

A process including the steps of: providing a planetary roller extruder having a plurality of compounding sections including a main spindle surrounded by and intermeshed with a plurality of planetary spindles; introducing monomers and initiator into a first compounding section; producing a homogeneous composition; heating the composition to initiate free-radical polymerization; introducing monomers and initiator into one or more of the remaining compounding sections and continuing the polymerization; discharging the polymerized composition; and optionally, taking a portion of the composition discharged from the planetary roller extruder and returning it to the first compounding section.

### CROSS REFERENCE TO RELATED APPLICATION

This application claims the benefit of U.S. Provisional Application Ser. No. 60/761,535 filed on Jan. 24, 2006 which is incorporated herein by reference.

### BACKGROUND OF INVENTION

The present invention relates to a continuous bulk polymerization process for preparing compositions such as (but not limited to) adhesive compositions using a planetary roller extruder (PRE). Conventional batch-wise bulk (e.g., limited solvent or water) processes to produce an adhesive by free radial polymerization are known. Typically, a reactor vessel (e.g., stirred tank) is jacketed to provide a cooling medium such that the heat generated during the exothermic reaction may be removed from the reactor vessel. At low conversion rates this conventional process has been somewhat effective; however, at high conversion rates and associated high viscosities the heat transfer surfaces often foul thereby losing temperature control and facilitating a runaway reaction. Mandating low conversion rates is not economical as the excess monomer must be removed from the polymer by an additional processing step such as de-volatilization, or the like, before the polymer can be used.

It has been found that PREs are well suited to the processing of highly exothermic reactions, such as the free radical polymerization of alkyl acrylate compounds, because thin layers of compound can be exposed to large surface areas thereby resulting in effective heat exchange, mixing and temperature control.

U.S. Published Application 2005/0170086A1 discloses a PRE which is reproduced in FIG. 1 herein. FIG. 1 shows a longitudinal section view of one example of a PRE 10′ including a feeding section 12′ and a compounding section 14′. The primary adhesive raw materials are added into the feed throat 16′ and metered onto the conveying screw 18′ of the feeding section 12′. As used herein, the term “primary raw materials” refers to those materials of the adhesive formulation added into the feed section 12′ of the PRE 10′. Primary raw materials may include, but are not limited to elastomers, resins, extenders, activators, anti-degradents and crosslinking agents. The screw 18′ conveys the primary raw materials into the compounding section 14′. FIG. 1 includes four planetary roller barrel sections 20′a, 20′b, 20′c and 20′d separated by dosing rings 22′a, 22′b and 22′c. Each roller barrel section 20′ includes a 45° helical toothed cylinder 24′, a 45° helical toothed main spindle 26′ and a plurality of 45° helical toothed planetary spindles 28′, 30′. The planetary spindles 28′, 30′ also mesh with the internal gearing of the cylinder section 24′. The helical gearing of the main spindle 26′, the planetary spindles 28′, 30′ and the cylinder section 24′ conveys the raw materials to be compounded in the direction of the discharge orifice 34′. Secondary solid raw materials can be added to the compounding section 14′ through a side feeder 36′ or twin screw dosing units 38′. The twin screw dosing units 38′ are typically positioned perpendicular to the longitudinal axis of the compounding section 14′ and are typically located near the beginning of the compounding section 14′ directly adjacent to the dosing ring 22′a. The twin screw dosing units 38′ can be employed to introduce solid components such as thermoplastic elastomers, resins, extenders, activators, anti-degradents, crosslinkers, etc., to the individual roller barrel sections 20′.

### SUMMARY OF INVENTION

The present invention relates to a process including the steps of: providing a planetary roller extruder having a plurality of compounding sections including a main spindle surrounded by and intermeshed with a plurality of planetary spindles; introducing monomers and initiator into a first compounding section; producing a homogeneous composition; heating the composition to initiate free-radical polymerization; introducing monomers and initiator into one or more of the remaining compounding sections and continuing the polymerization; discharging the polymerized composition; and optionally, taking a portion of the composition discharged from the planetary roller extruder and returning it to the first compounding section.

In one embodiment of the invention, at least one of the planetary spindles is a double transversal mixing spindle comprising a plurality of back-cut helical flights. In one embodiment of the invention a self-adhesive composition is produced that is the reaction product of at least one alkyl acrylate monomer having at least one free radical polymerizable moiety and an initiator is manufactured by the aforementioned process. Some embodiments of the invention provide a 99.5% or higher yield. In certain processes for manufacturing compositions prepared at high conversion rates by a PRE process in accordance with certain aspects of the invention, the polymerized composition is discharged from the extruder at a temperature below about 240° C., in some cases below about 200° C., and in other cases below about 120° C.

In accordance with certain embodiments of the present invention, the self-adhesive composition may be applied to a web-formed material using an application unit such as a slot-die applicator unit and subsequently may be crosslinked. Further embraced by one embodiment of the invention is a self-adhesive tape including the pressure-sensitive adhesive (PSA) composition on at least one side of a backing material in web form.

### BRIEF DESCRIPTION OF THE DRAWING

FIG. 1 is a longitudinal sectional view of a planetary roller extruder known in the art from Published Application 2005/0170086A1; and

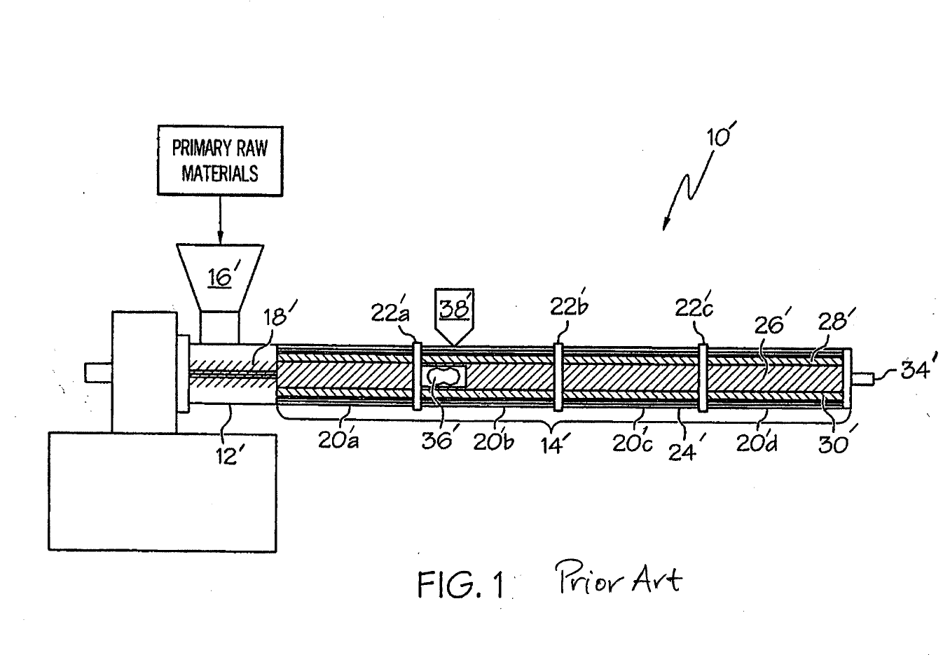

FIG. 2 is a schematic illustration of the disclosed planetary roller extruder process.

### DETAILED DESCRIPTION OF INVENTION

PREs typically have a filling section and a compounding section. The filling section typically includes a conveying screw to which certain raw materials are fed continuously. The conveying screw transports the material to the compounding section. The compounding section includes a driven main spindle and a number of planetary spindles which rotate around the main spindle within a roll cylinder with internal helical gearing. The rotary speed of the main spindle and hence the rotational speed of the planetary spindles can be varied and is one parameter to be controlled during the compounding and bulk polymerization process. The materials are circulated between the main and planetary spindles, or between the planetary spindles and the helical gearing of the roll section, so that the materials are dispersed to form a homogeneous composition.

The PRE processes of the invention may be used to produce a wide variety of coatings such as, but not limited to, release coatings, primer coatings, non-PSA adhesives, sealants, caulks, paper saturants, acrylic hybrid PSA's and non-PSA coatings (e.g., urethane acrylics, epoxy acrylics, styrene acrylics, and the like).

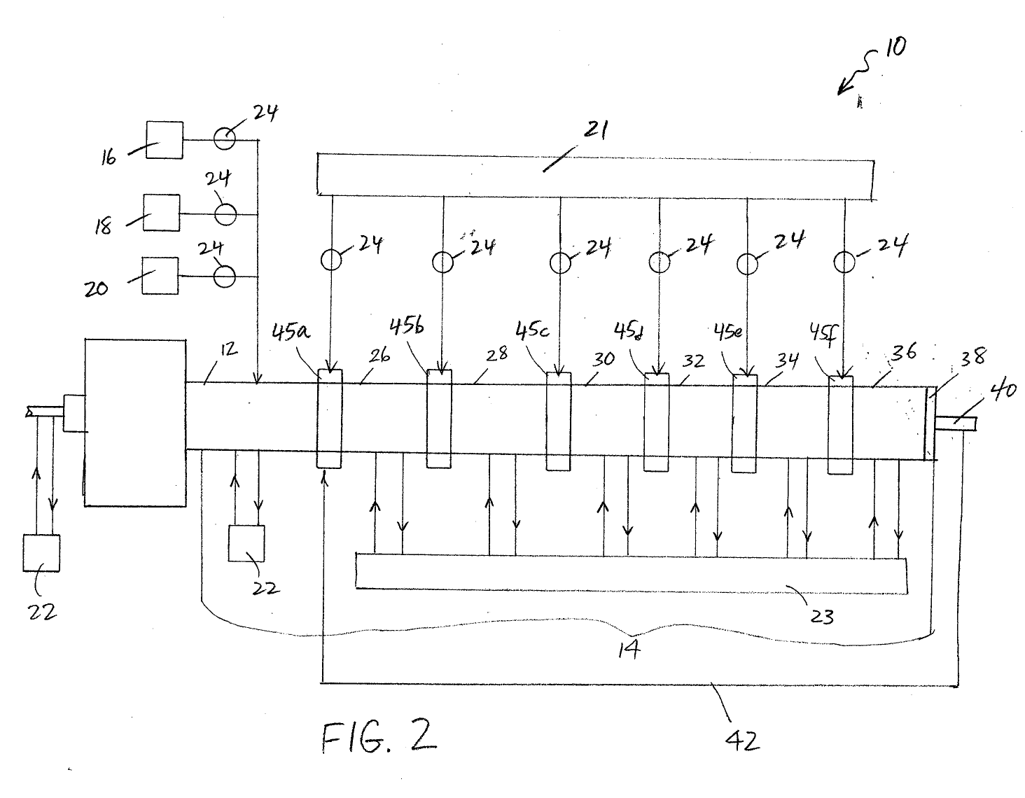

In one embodiment of the present invention, an acrylic PSA product may be prepared by the PRE process, as shown in FIG. 2. The PRE, generally designated 10 includes consecutive compounding sections 14. The primary raw materials include a first monomer 16, a second (optional) monomer 18, an initiator 20, and secondary raw materials (e.g., the first monomer premixed with initiator) 21. The primary raw materials 16, 18, 20 are metered into the first compounding section 12, combined, and heated to a temperature sufficient to initiate the free-radical reaction process. Accurate temperature control is maintained within the first compounding section 12 by conducting the cooling water 22 through the barrel wall and close to the intermeshing surfaces, as well as through a central bore in the conveying screw. Micro-annular gear pumps 24 provide a highly precise dosage of primary raw materials 16, 18, 20 into the first compounding section 12. In one embodiment, these microannular gear pumps 24 (MZR® model 7205) are manufactured by HNP Mikrosysteme (Parchim, Germany). The reacting mixture is carried into the second planetary roller zone 26, where secondary raw materials 21 may be added to the mixture by microannular gear pumps 24 via injection nozzles (not shown) through the dispersion ring assemblies 45. At this point in the process, the highly exothermic reaction is generating heat; however, the intensive cooling of the PRE maintains the polymer process temperature below about 240° C., (e.g., the minimum degradation temperature for acrylic polymers and copolymers) by directing cooling water 23 to each planetary roller.

In one embodiment, the PRE includes a first compounding section that includes a planetary roller zone into which solid or liquid raw materials, e.g., monomers, resins, extenders, activators, antidegradents, and crosslinking agents, etc. can be introduced via injection nozzles through the dispersion or dosing ring assemblies. In one embodiment, a PRE having six compounding sections, e.g., six planetary roller barrel sections separated by stop or dosing rings. However, PRE's having as few as 1 to as many as 12 or more compounding sections may be used.

A second planetary roller zone 28, a third planetary roller zone 30, a fourth planetary roller zone 32, a fifth planetary roller zone 34, and a sixth planetary roller zone 36 may be adapted for further additions of the secondary raw materials 21 and the residence time required to minimize the residual monomer content of the finished polymer. The flight design in each zone may be the same or different. In the illustrated embodiment, following the sixth zone 36, the finished polymer melt exits through a chilled baffle ring 38, and may be further conveyed through a transfer pipe 40 and to a de-volatilization station (not shown) and/or a coating head (not shown). Conversions less than 99.5% may require de-volatilization to remove the excess monomer from the polymer. Melt temperature readouts (not shown) may be provided for each planetary roller zone 26, 28, 30, 32, 34, 36 to assist the process operator with temperature control.

The PRE includes several planetary roller zones (e.g., 26, 28, 30, 32, 34, 36). Each of these zones 26, 28, 30, 32, 34, 36 are preceded by a dispersion ring assembly 45a, 45b, 45c, 45d, 45e, 45f that allows for the introduction of the secondary raw materials 21. In one embodiment, each planetary roller zone 26, 28, 30, 32, 34, 36 consists of a 45° helical toothed cylinder, a 45° helical toothed main spindle and three or more 45° helical toothed planetary spindles but the cylinder and spindle construction may vary from one zone to the next to accommodate the polymer characteristics encountered in that zone. The maximum number of planetary spindles is a function of the diameter of the cylinder.

In one embodiment of the disclosed process shown in FIG. 2, a portion of the composition 42 exiting the transfer pipe 40 may be returned to planetary roller zone 26 using dispersion ring assembly 45a. Recirculation of a portion of the composition 42 exiting the transfer pipe 40 extends the polymerization reaction residence time and provides a yield of 99.5% or higher. In another embodiment, a portion of the composition 42 exiting the transfer pipe 40 may be returned to any of the planetary roller zones 26, 28, 30, 32, 34, 36 using any of the dispersion ring assemblies 45a, 45b, 45c, 45d, 45e, 45f.

The planetary spindles can exhibit many different tooth geometries, e.g., full helical flights (Planetspindel), back-cut helical flights (Noppenspindel), or zoned helical flights (Igelspindel). etc. The number of planetary spindles is a function of the diameter of the cylinder. The planetary spindles can exhibit many different tooth geometries, e.g. full helical flights (Planetspindel), back-cut helical flights (Noppenspindel), or zoned helical flights (Igelspindel), etc. A PRE with all full flight spindles does less work on the polymer than a PRE with spindles in which a portion of the flights is open or back-cut. The number of planetary spindles chosen and their geometries (e.g., open vs. full flight) can be designed in such a way as to control the rate with which material passes through the PRE and hence the dynamic discharging effect of each zone 26, 28, 30, 32, 34, 36. Conventional PREs contain at least 3 and can contain up to 20 spindles, depending on the diameter of the cylinder and process design. In one embodiment of the invention, a PRE having a 70 mm diameter cylinder having 6 spindles is used. Another factor that affects the movement of material through the PRE is the internal diameter of the stop ring. By narrowing the gap between the stop ring or doing ring and the spindle, more work can be performed on the resin. Liquid materials, e.g. monomers, initiators, molten resins, oils, solvents, etc., can be introduced into the compounding zones 26, 28, 30, 32, 34, 36 via injection nozzles (not shown) through the dispersion ring assemblies 45a, 45b, 45c, 45d, 45e, 45f. In one embodiment of the invention, solid components, e.g., thermoplastic elastomers, tackifying resins, extenders, activators, crosslinkers, and colorants, in addition to liquid components, may be fed into the compounding sections of the PRE via a sidefeeder. Moreover, each zone 26, 28, 30, 32, 34, 36 can be modified with twin-screw dosing units (not shown). The twin screw dosing units are typically positioned perpendicular to the axis of the zones 26, 28, 30, 32, 34, 36 and are typically located near the beginning of the zones 26, 28, 30, 32, 34, 36 directly adjacent to the dispersion ring assemblies 45a, 45b, 45c, 45d, 45e, 45f. The twin-screw dosing units can be employed to introduce solid components, e.g. tackifying resins, extenders, anti-degradents, crosslinkers, etc., to the zones 26, 28, 30, 32, 34, 36.

The coated adhesive composition may be crosslinked with the aid of electron beams or UV energy in a manner known in the art. For example, crosslinking the adhesive using UV energy requires the addition of appropriate UV promoters (e.g., photoinitiators, such as peroxides). If desired, the UV promoters can be added via the PRE process without departing from the scope of the invention.

In the event that additional tack and adhesion are required, resins and/or oils can be added via the PRE process without departing from the scope of the invention. In the event that color or other properties need to be modified; pigments, fillers or anti-degradants may be added via the PRE process without departing from the scope of the invention.

Typical monomers employed in this process include, but are not restricted to, ethylenically unsaturated monomers such as alkyl acrylate monomer(s) or mixtures of alkyl acrylate monomer(s) having, for example, an alkyl group with from 2 to 20, and preferably 4 to 10 carbon atoms. Preferred alkyl acrylate monomers include: 2-ethylhexyl acrylate (2-EHA), butyl acrylate (BA), isooctyl acrylate (IOA), isodecyl acrylate (IDA), and any other monomers or mixtures thereof, known to those skilled in the art. Di-vinyl monomers can be used to increase the molecular weight and the internal strength of the polymer backbone and are generally employed in one embodiment in amounts up to about 11% by weight of the acrylic polymer. Suitable vinylic monomers employed in the practice of certain embodiments of the present invention include styrene (ST), alpha methyl styrene (AMS), tetraethylene glycol diacrylate (TEGDA), hydroxyethyl methacrylate (HEMA), methylmethacrylate (MMA), ethylacrylate (EA), methylacrylate (MA) propylacrylates (PA), propylmethacrylates (PMA), hexylacrylates (HA), hexylmethacrylates (HMA), and vinyl acetate. Examples of initiators include hydroperoxides of olefins, di-alkyl peroxides, diaryl peroxides, alkyl polyperoxides, tranannular peroxides, peroxy acids, peroxy esters, diacyl peroxides, diaroyl peroxides, dialkyl peroxydicarbonates, and peroxy derivatives of aldehydes and ketones. The initiators include compounds such as persulfates, tert-butyl hydroperoxide and similar peroxide catalysts and azo compounds, such as azobis-isobutylnitrile and dimethyl azobis-isobutyrate. Typical tackifying resins include partially or fully hydrogenated wood, gum, or tall oil rosins, esterified wood, gum or tall oil rosins, alpha and beta pinene resins, and polyterpene resins. The resins can be introduced in both solid and molten form. Typical anti-degradents include antioxidants (AO), ultraviolet absorbers (UVA), and ultraviolet stabilizers (UVS). Typical crosslinking agents include peroxides, ionic, thermally activated resins, isocyanate, UV, and/or EB activated curing agents. Typical colorants are titanium dioxide and other various metal pigments. Typical solvents are liquid carboxylates such as ethyl acetate and n-butyl acetate, ketones such as acetone, dimethyl ketone and cyclohexanone, aromatic hydrocarbons such as benzene, toluene, and the xylenes, liquid aliphatic and cyclo-aliphatic hydrocarbons such as petroleum fractions having boiling points of between 50 and 150° C. and in particular between 60 and 100° C., cyclohexane, and others such as dioxane, tetrahydrofuran and di-t-butyl ethers or mixtures thereof.

In one embodiment of the invention, an adhesive or pressure sensitive adhesive is provided that is the reaction product of about 65 to 95% butyl acrylate, about 5 to 25% vinyl acetate, and about 1 to 9% acrylic acid.

Particularly useful solvents for the adhesive composition of this invention are liquid carboxylates such as ethyl acetate and n-butyl acetate, ketones such as acetone, dimethyl ketone and cyclohexanone, aromatic hydrocarbons such as benzene, toluene, and the xylenes, liquid aliphatic and cyclo-aliphatic hydrocarbons such as petroleum fractions having boiling points of between about 50 and 150° C. and in particular between about 60 and 100° C., cyclohexane, and others such as dioxane, tetrahydrofuran and di-t-butyl ethers or mixtures thereof. Particularly useful solvents for the adhesive composition of this invention are ethyl acetate, cyclohexane, and mixtures of acetone with petroleum ether (e.g., having a boiling point 60 to 95° C.). Solvent can be added to yield solids percentage of about 20 to 100%. Solvent can be added into the process via injection nozzles through the dispersion ring assemblies. The solvent may be added to adjust the viscosity of the adhesive so that the adhesive to be applied via the selected coating process, e.g., low viscosity coating processes (e.g.; knife over roll).

The introduction of monomers into consecutive planetary roller zones 26, 28, 30, 32, 34, 36 yields a random copolymer instead of block copolymer. The use of dispersion ring assemblies 45a, 45b, 45c, 45d, 45e, 45f permits one to feed reactants directly into the polymerizing mass and achieve a homogeneous blend quickly.

The continuous production/production-on-demand of self-adhesive materials has the advantage of minimizing work in process, matching adhesive production with adhesive demand. This eliminates adhesive inventory and lowers overall cost.

The use of a slot-die for coating adhesives to web-form material has particular advantages over the traditional roll-over-roll and knife over roll processes. One slot die unit that is used in one embodiment includes a rotating spindle that trails the die lip, commonly known as a rotating lip die. One example of such a die is commercially available from SIMPLAS. Web-form adhesive coating speeds, when employing the traditional roll-over-roll and knife over roll processes are typically limited to viscosities of 40,000 cPs or less and are not conducive to high solids adhesives. However, the use of slot-die coating technology, particularly when employed in conjunction with self-adhesives produced by the PRE process may be of particular interest as application speeds easily achieve 500 meters per minute and sometimes can exceed 900 meters per minute.

Depending on the intended use of the adhesive tape, suitable web-form carrier materials for the self-adhesive compositions processed and produced in accordance with the invention are all known carriers, with or without appropriate chemical or physical surface pretreatment of the coating side, and anti-adhesive physical treatment or coating of the reverse side. Representative examples include: creped, non-creped, and release papers, polyethylene, polypropylene, mono- or biaxially oriented polypropylene films, polyester, PVC, release and other films, as well as foamed materials, wovens, knits, and nonwovens in web form made from polyolefins.

Having described the invention in detail and by reference to the preferred embodiments, it will be apparent that modifications and variations thereof are possible without departing from the scope of the invention as described herein.

What is claimed is:

1. A process including the steps of:
providing a planetary roller extruder having a plurality of compounding sections including a main spindle surrounded by and intermeshed with a plurality of planetary spindles;
introducing monomers and initiator into a first compounding section;
producing a homogeneous composition;
heating the composition to initiate free-radical polymerization;
introducing monomers and initiator into one or more of the remaining compounding sections and continuing the polymerization;
discharging the polymerized composition; and
optionally, taking a portion of the composition discharged from the planetary roller extruder and returning it to the first compounding section.

2. The process of claim 1, wherein the polymerized composition is a self-adhesive composition which comprises the polymerization reaction product of at least one alkyl acrylate monomer having at least one free radical moiety and a heat-activated initiator and the polymerized composition is coated on a web.

3. The process of claim 1, wherein at least one of the planetary spindles is a double transversal mixing spindle comprising a plurality of back-cut helical flights.

4. The process of claim 3, wherein the process provides a yield of 99.5% or higher.

5. The process of claim 4, wherein the composition exiting the process exits at a temperature below about 240° C.

6. The process of claim 5, wherein the composition exiting the process exits at a temperature below about 200° C.

7. The process of claim 6, wherein the composition exiting the process exits at a temperature below about 120° C.

8. The process of claim 1, wherein the monomer includes an alkyl acrylate.

9. The process of claim 1, wherein the polymerized composition is a release coating.

10. The process of claim 1, wherein the polymerized composition is a primer coating.

11. The process of claim 1, wherein the polymerized composition is a non-PSA adhesive.

12. The process of claim 1, wherein the polymerized composition is a sealant coating.

13. The process of claim 1, wherein the polymerized composition is a caulk coating.

14. The process of claim 1, wherein the polymerized composition is a paper saturant.

15. The process of claim 1, wherein the polymerized composition is an acrylic hybrid PSA.

16. The process of claim 1, wherein the polymerized composition is a non-PSA coating.
